(19) United States
(12) Patent Application Publication
(10) Pub. No.: US 2016/0321838 A1
(43) Pub. Date: Nov. 3, 2016

(54) SYSTEM FOR PROCESSING A THREE-DIMENSIONAL (3D) IMAGE AND RELATED METHODS USING AN ICP ALGORITHM

(71) Applicant: STMicroelectronics S.R.L., Agrate Brianza (IT)

(72) Inventor: Massimiliano BARONE, Cormano (IT)

(21) Appl. No.: 15/142,119

(22) Filed: Apr. 29, 2016

Related U.S. Application Data
(60) Provisional application No. 62/154,321, filed on Apr. 29, 2015.

(51) Int. Cl. G06T 15/60; G06T 15/20; G06T 3/60; G06T 3/20; H04N 1/00; G06T 15/00

(52) U.S. Cl. CPC G06T 15/60; H04N 1/00827; G06T 15/00; G06T 3/60; G06T 3/20; G06T 15/20

(57) ABSTRACT

A system for processing a three-dimensional (3D) image may include a processor and a memory cooperating therewith configured to extract a subject for a given image frame from a plurality of image frames and generate first and second image-point subject models based upon a previous image frame and a next image frame, respectively. The processor may also perform a first iterative closed points (ICP) algorithm on the first and second image-point subject models producing common points, remove not common points to define updated first and second image-point subject models, and perform, based upon the common points, a second ICP algorithm on the updated first and second image-point subject models to define further updated first and second image-point subject models. The processor may further generate a 3D image based upon the further updated first image-point subject model and the further updated second image-point subject model after performing the second ICP algorithm.

### TECHNICAL FIELD

The present invention relates to the field of imaging and, more particularly, to digital image processing and related methods.

### BACKGROUND

A three-dimensional (3D) scanner includes two main parts. The first stage is the acquisition based on sensor technology to produce RGB-Z data, colored images and depth maps. The 3D scanner can be a time-of-flight (TOF) plus an RGB-camera, an infrared projector plus IR-RGB-cameras or a code-bar projectors, or an RGB camera stereo matching. Once such scanner is the Kinect scanner which is based upon infrared technology (FIGS. 1a and 1b). The output of the Kinect is an RGB-Z stream (FIG. 2). The RGB-Z stream is the input of the second stage that elaborates data to produce a 3D model of the whole scene or the single subject (FIG. 3).

A 3D Scanner includes several parts from an algorithm point of view. The first stage is the acquisition as described above. The second stage is the elaboration that includes other modules of the whole pipeline. The first module is the optional clipping of the working range, the second one is the optional coarse rotation and translation (RT) transform estimation, and the third one is the estimation of 3D correspondences between two 3D models coming from two views, and this phase is also called registration. The previous view is called the Target while the next is the Source.

There are generally three kinds of algorithms for correspondences. One algorithm is the iterative closed points (ICP) algorithm that reduces the sum of all 3D correspondence distances between the target and the source. There are many variants of ICP.

Another alternative is a method based on geometric descriptor matching. Another technique is based on linearization and numeric solving of 3D correspondence signed distances function (SDF) between the target and the source.

The fourth module is the estimation of the RT estimation using a known closed form. The fifth one is the fusion of the source with the incremental model. The fusion of all 3D models is also called the integration phase (FIG. 4). Each approach is different with respect to the algorithms used inside the stages and also about the composition of pipeline chain.

ICP for Registration

With respect to using ICP for registration, the goal is to align partially two 3D models; they are called the target and the source. This is equivalent to an estimation of the RT relative transform (FIG. 5). ICP for registration reduces the sum of all 3D correspondence distances between target and source. The method is iterative. For each trial, an RT is estimated, and the source is moved using that transformation. If the trial is not sufficient with respect to converge criteria, another trial is applied until a minimum sum 3D distance is reached. The method converges if the starting position of the source is close to the target, otherwise, a local minimum could be found instead of the correct global minimum.

In typical operation, to increase the probability to have closed models, the barycenter is calculated and a simple translation of the source is performed to have the same barycenter. If the models are exactly the same, the convergence is generally always granted.

ICP uses a k-d tree to organize data and to allow a relatively fast minimum distance between a point of the source and all points of the target. In fact, the complexity is Ns*log Nt, where the models have Nt points for the target and Ns points for the source. To increase the speed of searching, the source model is generally always sampled before the application of ICP. The closed models that may be used to estimate the RT may be the horn or SVD method, for example.

A basic ICP is described below:

Select e.g. 1000 random points;

Match each to the closest point on the other scan, using a data structure such as a k-d tree;

Reject pairs with distance>k times median;

Construct error function:

E=Σ|Rpᵢ+t−qᵢ|²

Minimize (closed form solution in [Horn 87]); and

Loop until converge is not reached.

Alternative Registration Based on the 3D Descriptor

The problem of registering a pair of point cloud datasets together is often referred to as pairwise registration, and its output is usually a rigid transformation matrix (4×4) representing the rotation and translation that would have to be applied on one of the datasets (called, for example, source) in order for it to be aligned with the other dataset (called, for example, target, or model).

The steps performed in a pairwise registration step are shown in the diagram in FIG. 6. It should be noted that a single iteration of the algorithm is being represented. A programmer can decide to loop over any or all of the steps.

The computational steps for two datasets may be considered relatively straightforward:

from a set of points, identify interest points (i.e., keypoints) that best represent the scene in both datasets;

at each keypoint, compute a feature descriptor;

from the set of feature descriptors together with their XYZ positions in the two datasets, estimate a set of correspondences, based on the similarities between features and positions;

given that the data is assumed to be noisy, not all correspondences are valid, so reject those bad correspondences that contribute negatively to the registration process; and

from the remaining set of good correspondences, estimate a motion transformation. (See, for example, http://pointclouds.org/documentation/tutorials/registration api. php).

CopyMe3D

Another technique is called CopyMe3D. This technique is based on linearization and numeric solving of 3D correspondence distances function between the target and the source. In particular, the distance is calculated between depth maps. In fact, the source is moved by a hypothetical RT, so a new depth map is calculated and it is overlapped with the target to have pixel correspondences. Furthermore, a signed distance function (SDF), a weight function, and a color function are used and are defined for each 3D point within the reconstruction volume. To find the SDF minimum, the derivative is set to zero and the Gauss-Newton algorithm is applied, i.e., an iterative linearization D(Rxij+T) with respect to the camera pose at the current pose estimate and solving the linearized system, where D is the depth map and xij are the associated pixels. Similar to the ICP method, the method converges if the starting position of the source is close to the target, otherwise a local minimum could be found instead of the correct global minimum. Besides, the SDF value management of outside target depth map may also be a factor.

Method Used by Point Cloud Library

Another method uses a point cloud library. This method represents the whole chain applied for a 3D scanner into a point cloud library. With respect to input data processing, the normals are computing for the following processing stages. A foreground mask is created which stores ‘true’ if the input point is within a specified volume of interest (cropping volume). This mask erodes a few pixels in order to remove border points. The foreground points are segmented into hand and object regions by applying a threshold to the color in the HSV color space. The hands region is dilated a few pixels in order to reduce the risk of accidentally including hand points into the object cloud. Only the object points are forwarded to the registration.

With respect to registration, the processed data cloud is aligned to the common model mesh using the iterative closest point (ICP) algorithm. The components includes fitness, which is the mean squared Euclidean distance of the correspondences after rejection, and pre-selection, which discards model points that are facing away from the sensor. The components also include a correspondence estimation, which is the nearest neighbor search using a kd-tree, and a correspondence rejection, which discards correspondences with a squared Euclidean distance higher than a threshold. The threshold is initialized with infinity (no rejection in the first iteration) and set to the fitness of the last iteration multiplied by a user defined factor. Correspondences are discarded where the angle between their normals is higher than a user defined threshold.

The components also include a transformation estimation, which is the minimization of the point to plane distance with the data cloud as source and model mesh as target, and convergence criteria. The convergence criteria includes epsilon, wherein convergence is detected when the change of the fitness between the current and previous iteration becomes smaller than a user defined epsilon value. The components also include failure criteria, which is when the maximum number of iterations has been exceeded, the fitness is bigger than a user defined threshold (evaluated at the state of convergence), and the overlap between the model mesh and data cloud is smaller than a user defined threshold (evaluated at the state of convergence).

With respect to integration, an initial model mesh (unorganized) is reconstructed, and the registered data clouds (organized) is merged with the model. Merging is done by searching for the nearest neighbors from the data cloud to the model mesh and averaging out corresponding points if the angle between their normals is smaller than a given threshold. If the squared Euclidean distance is higher than a given squared distance threshold the data points are added to the mesh as new vertices. The organized nature of the data cloud is used to connect the faces. The outlier rejection is based on the assumption that outliers can't be observed from several distinct directions. Therefore each vertex stores a visibility confidence which is the number of unique directions from which it has been recorded. The vertices get a certain amount of time (maximum age) until they have to reach a minimum visibility confidence and else are removed from the mesh again. The vertices store an age which is initialized by zero and increased in each iteration. If the vertex had a correspondence in the current merging step the age is reset to zero. This setup makes sure that vertices that are currently being merged are always kept in the mesh regardless of their visibility confidence. Once the object has been turned around certain vertices cannot be seen anymore. The age increases until they reach the maximum age when it is decided if they are kept in the mesh or removed. (See http://pointclouds.org/documentation/tutorials/in hand scanner.p hp#in-hand-scanner, for example).

University of Padova

Another method is set forth by the University of Padova. The flow chart in FIG. 7 illustrates this method. The approach is fully state of art. The T estimation (Block 72) is based on a standard barycenter calculation. The source sampling (Block 74) is based on standard salient points: strong depth variation, strong normals variation and strong color variation. The registration (Block 76) is based on a fifth dimensional ICP, where the a, b components of the CeLab color space are added. The fusion (Block 78) includes on a simple average based on 3D voxel between the global model and the source model. In the last stage, the standard outliers are removed (Block 84) based on the k nearest neighbors when it is determined whether the current frame is the last frame (Block 80). The distance distribution of k points from the points selected gives the standard deviation distance, called std, used to discover the out of distribution. The outlier points are higher than the mean+std*h, where h is a coefficient>1. If the current frame is not the last frame such that the target equals the source (Block 82), the method returns to Block 72.

Kinect Fusion

Yet another method, as mentioned above, is the Kinect fusion method. The corresponding system includes four main stages (FIG. 8). The first state is the depth map conversion. The live depth map is converted from image coordinates into 3D points (referred to as vertices) and normals in the coordinate space of the camera. The next stage is the camera tracking state, wherein a rigid 6DOF transform is computed to closely align the current oriented points with the previous frame, using a GPU implementation of the Iterative Closest Point (ICP) algorithm. Relative transforms are incrementally applied to a single transform that defines the global pose of the Kinect.

The third state is the volumetric integration stage. Instead of fusing point clouds or creating a mesh, a volumetric surface representation is used and based on the technical article entitled, “A volumetric method for building complex models from range images,” ACM Trans. Graph., 1996. Given the global pose of the camera, oriented points are converted into global coordinates, and a single 3D voxel grid is updated. Each voxel stores a running average of its distance to the assumed position of a physical surface.

The fourth stage is the raycasting stage. Finally, the volume is raycast to extract views of the implicit surface, for rendering to the user. When using the global pose of the camera, this raycasted view of the volume also equates to a synthetic depth map, which can be used as a less noisy more globally consistent reference frame for the next iteration of ICP. This allows tracking by aligning the current live depth map with our less noisy raycasted view of the model, as opposed to using only the live depth maps frame-to-frame.

### SUMMARY

A system for processing a three-dimensional (3D) image may include a processor and a memory cooperating therewith. The processor may cooperate with the memory to extract a subject for a given image frame from a plurality of image frames and generate first and second image-point subject models based upon a previous image frame and a next image frame, respectively. The processor may also cooperate with the memory to perform a first iterative closed points (ICP) algorithm on the first and second image-point subject models producing common points, remove common points to define updated first and second image-point subject models, and perform, based upon the common points, a second ICP algorithm on the updated first and second image-point subject models to define further updated first and second image-point subject models. The processor may also cooperate with the memory to generate a 3D image based upon the further updated first image-point subject model and the further updated second image-point subject model after performing the second ICP algorithm. Accordingly, the system may provide increased efficiency, for example, and may provide a more robust subject extraction and increased quality.

The processor may be configured to perform a coarse rotation and translation (RT) estimation of the extracted subject prior to performing the first ICP algorithm. The processor may be configured to remove points of the image frame in at least one of the previous image frame and the next image frame that are outside a threshold boundary based upon the coarse RT estimation, for example.

The processor may be configured to generate the second image-point subject model based upon less than an entirety of the next image frame. The processor may be configured to perform luminance equalization based upon the common points, for example. The processor may be configured to perform the luminance equalization by calculating coefficients of equalization, for example.

The processor may be configured to generate a depth map between the further updated first and second image-point subject models and link further updated first and second image-point models based upon an amount of overlap in the depth map. The processor may be configured to accumulate a plurality of previously processed next image frames. The processor may be configured to link the plurality of previously processed ones of the next image frames to the further updated first and second image-point subject models, for example.

The processor may be configured to extract at least one normal from the further updated second image-point subject model based upon a threshold number of neighbors for a given point in the second image-point subject model. The processor may be configured to perform a fine RT estimation based upon the second ICP algorithm.

A method aspect is directed to a method of processing a three-dimensional (3D) image using a processor and a memory cooperating therewith. The processor is used to extract a subject for a given image frame from a plurality of image frames, generate first and second image-point subject models based upon a previous image frame and a next image frame, respectively, and perform a first iterative closed points (ICP) algorithm on the first and second image-point subject models producing common points. The processor is also used to remove not common points to define updated first and second image-point subject models and perform, based upon the common points, a second ICP algorithm on the updated first and second image-point subject models to define further updated first and second image-point subject models. The processor is further used to generate a 3D image based upon the further updated first image-point subject model and the further updated second image-point subject model after performing the second ICP algorithm.

### BRIEF DESCRIPTION OF THE DRAWINGS

FIGS. 1a and 1b are photographs of a Kinect system in accordance with the prior art.

FIG. 2 is a series of output images from the Kinect system of FIG. 1.

FIG. 3 is a 3D model obtained based upon the series of output images of FIG. 2.

FIG. 4 is a flow chart illustrating a full chain of a generic 3D scanner in accordance with the prior art.

FIG. 5 is an image illustrating an example of 3D alignment in accordance with the prior art.

FIG. 6 is a flow chart illustrating the steps performed in a single iteration of a pairwise registration in accordance with the prior art.

FIG. 7 is a flow chart illustrating an image processing approach in accordance with the prior art.

FIG. 8 is a schematic diagram of a Kinect fusion system pipeline in accordance with the prior art.

FIGS. 9a and 9b are images illustrating a 3D model not well globally registered versus a well global registered model, respectively, as in the prior art.

FIG. 10 is a flow chart for processing a 3D image in accordance with embodiment.

FIG. 11 is a more detailed flow chart of a 3D image processing method in accordance with an embodiment.

FIGS. 12a-12c are exemplary images of subject extraction and RGB mapping on a depth map in accordance with the prior art.

FIGS. 13a-13c are a subject, hand, and hand removed and new subject coloration according to the point cloud library method of the prior art.

FIGS. 14a and 14b are images of a partial and full subject extraction, respectively, in accordance with an embodiment.

FIGS. 15a and 15b are graphs of a 2D and 3D linear regression, respectively, in accordance with an embodiment.

FIGS. 16a and 16b are images of barycenter alignment and regression plane alignment in accordance with an embodiment.

FIGS. 17a and 17b are graphs of internal rotation into a same plane based upon an angle histogram in accordance with an embodiment.

FIGS. 18a and 18b are images of internal rotation into a same plane based upon an angle histogram in accordance with an embodiment.

FIGS. 19a-19d are images of a target, source mapped to target, source, and target mapped on the source in accordance with an embodiment.

FIG. 20 is an image after a 360-degree scan around the subject, with consecutive frames giving another surface above the previous in accordance with an embodiment.

FIG. 21 is an image after a 360-degree scan around the subject illustrating that target extraction from the global model in accordance with an embodiment.

FIGS. 22a-22c are images of a target and sampled source, initial ICP correspondences with uncommon points during a first cycle, and initial ICP correspondences without uncommon points on a second cycle, respective, in accordance with an embodiment.

FIGS. 23a and 23b are images showing the camera 2 m away from the subject for 20 frames and 0.7 m away from the subject for 40 frames, respectively.

FIG. 24 is an image illustrating depth map borders in accordance with the prior art.

FIG. 25 is a schematic diagram illustrating a first step of approximation according to an embodiment.

FIG. 26 is a schematic diagram illustrating a second step of approximation according to an embodiment.

FIG. 27 is a schematic diagram illustrating a third step of approximation according to an embodiment.

FIG. 28 is a schematic diagram illustrating a fourth step of approximation according to an embodiment.

FIGS. 29a and 29b are images before and after filter, respectively, in accordance with an embodiment.

FIG. 30 is a schematic diagram of quantized angle space in accordance with an embodiment.

FIGS. 31a-31c are images of a frame not equalized, frame 0, and a frame equalized as frame 0 in accordance with an embodiment.

FIGS. 32a and 32b are images illustrating before and after re-painting, respectively, in accordance with an embodiment.

FIGS. 33a-33c are images illustrating results of the image processing in accordance with an embodiment.

FIGS. 34a-34c are further images illustrating results of the image processing in accordance with an embodiment.

FIG. 35 is a block diagram of a system for executing the image processing method in accordance with an embodiment.

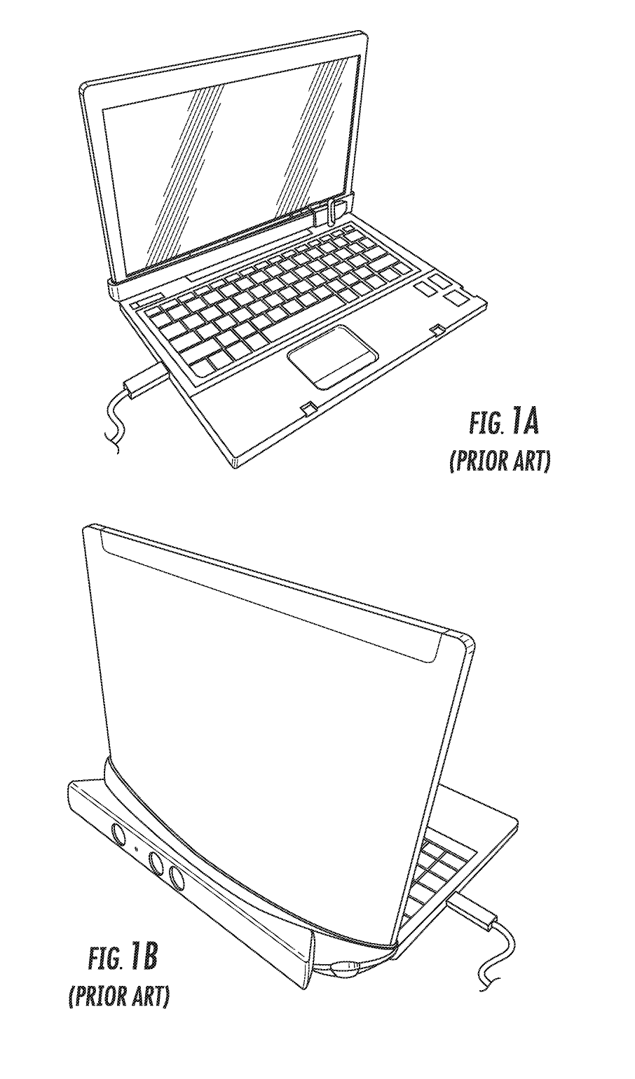

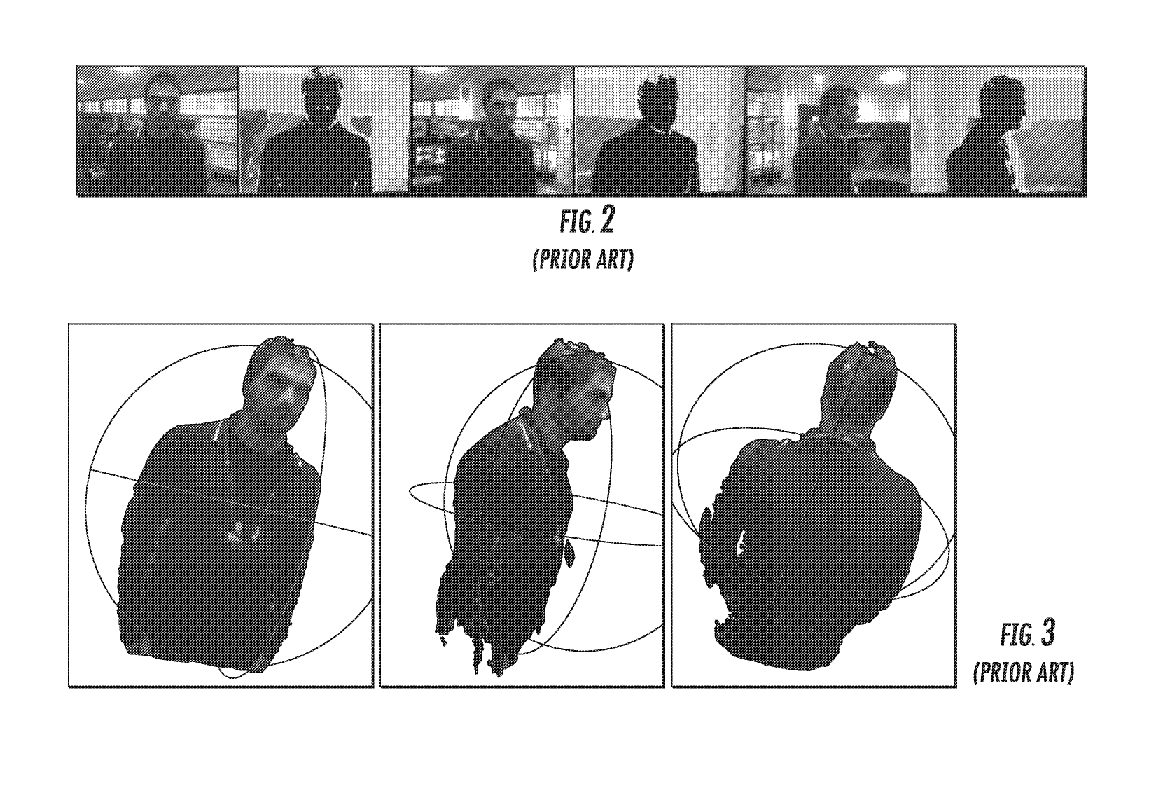

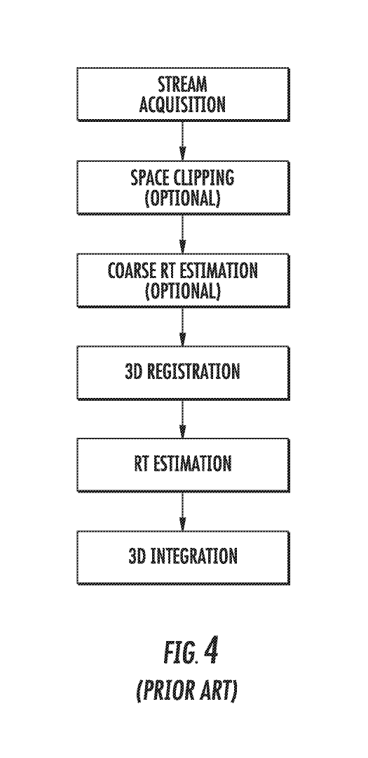

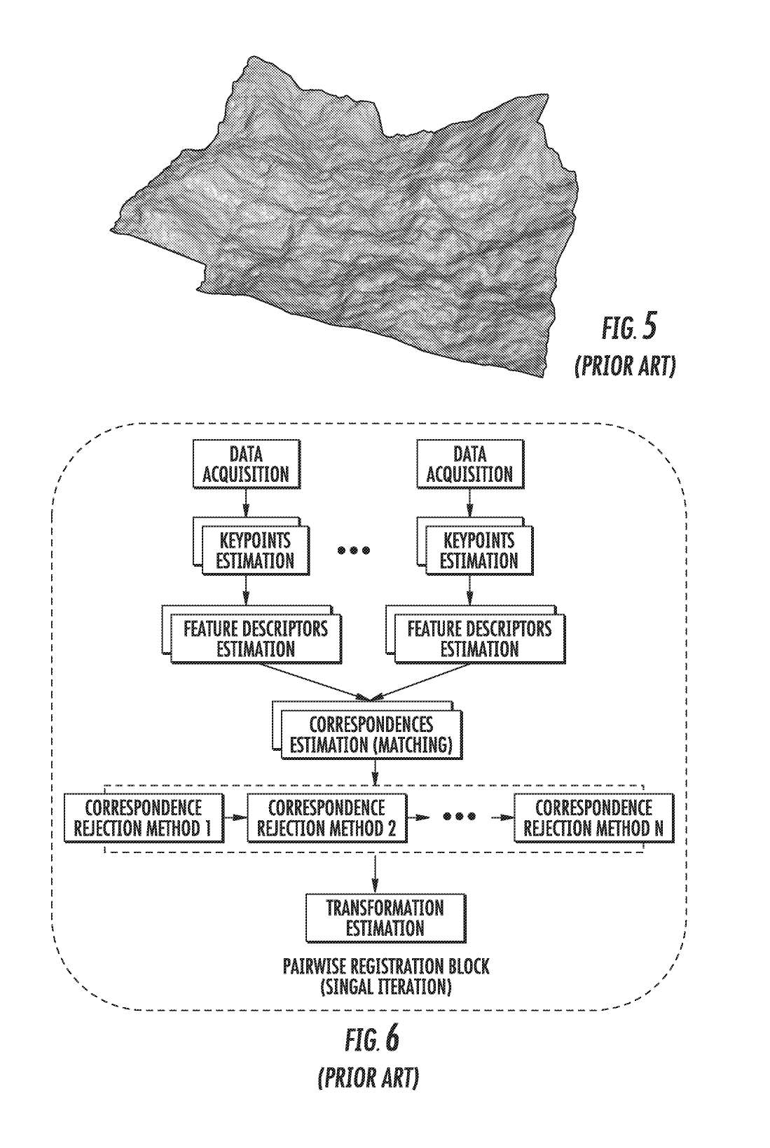

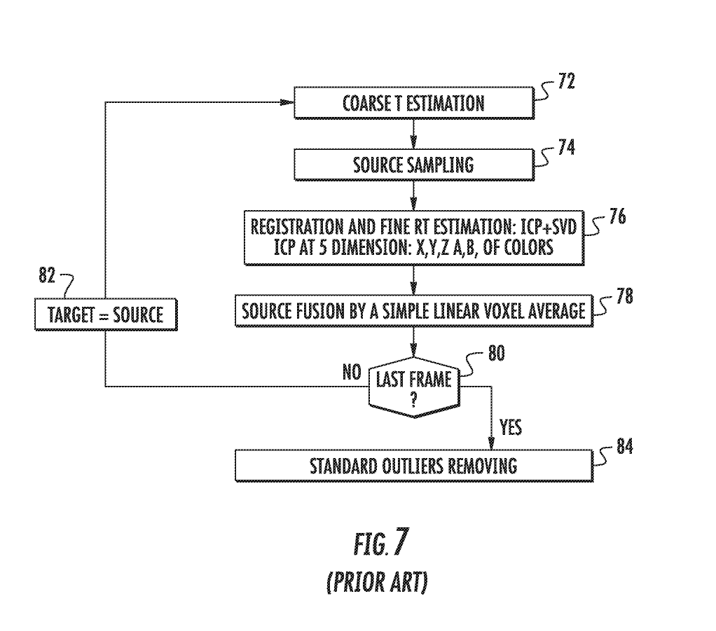

### DETAILED DESCRIPTION

The present invention will now be described more fully hereinafter with reference to the accompanying drawings, in which preferred embodiments are shown. These embodiments may take many different forms and should not be construed as limited to the embodiments set forth herein. Rather, these embodiments are provided so that this disclosure will be thorough and complete, and will fully convey the scope of the embodiments to those skilled in the art. Like numbers refer to like elements throughout.

With respect to camera tracking, ICP is a popular and well-studied algorithm for 3D shape alignment. In KinectFusion, ICP is instead leveraged to track the camera pose for each new depth frame, by estimating a single 6DOFb transform that closely aligns the current oriented points with those of the previous frame. This gives a relative 6DOF transform which can be incrementally applied together to give the single global camera pose Ti. The important first step of ICP is to find correspondences between the current oriented points at time i with the previous at i−1. In the system described in the present embodiments, a projective data association is used to find these correspondences. This part of the GPU-based algorithm is shown as pseudocode in Listing 1 below.
1: for each image pixel uεdepth map Di in parallel do
2: if Di(u)>0 then
3: vi−1←(T)̂(−1) i−1vg i−1
4: p←perspective project vertex vi−1
5: if pεvertex map Vi then
6: v←TiVi(p)
7: n←RiNi(p)
8: if ∥v−vgi−1∥<distance threshold and abs(n·ngi−1)<normal threshold then
9: point correspondence found.

### Listing 1

Given the previous global camera pose Ti−1, each GPU thread transforms a unique point vi−1 into camera coordinate space, and perspective projects it into image coordinates. It then uses this 2D point as a lookup into the current vertex (Vi) and normal maps (Ni), finding corresponding points along the ray (i.e. projected onto the same image coordinates). Finally, each GPU thread tests the compatibility of corresponding points to reject outliers, by first converting both into global coordinates, and then testing that the Euclidean distance and angle between them are within a threshold. Note that Ti is initialized with Ti−1 and is updated with an incremental transform calculated per iteration of ICP.

Given these set of corresponding oriented points, the output of each ICP iteration is a single transformation matrix T that minimizes the point-to-plane error metric, defined as the sum of squared distances between each point in the current frame and the tangent plane at its corresponding point in the previous frame:

arg min Sum(∥(Tvi(u)−vgi−1(u))·ngi−1(u)∥2)

A linear approximation is made to solve this system, by assuming only an incremental transformation occurs between frames. The linear system is computed and summed in parallel on the GPU using a tree reduction. The solution to this 6×6 linear system is then solved on the CPU using a Cholesky decomposition.

One of the key novel contributions of our GPU-based camera tracking implementation is that ICP is performed on all the measurements provided in each 640×480 Kinect depth map. There is no sparse sampling of points or need to explicitly extract features (although of course ICP does implicitly require depth features to converge). This type of dense tracking is only feasible due to our novel GPU implementation, and plays a central role in enabling segmentation and user interaction in KinectFusion, as described later.

With respect to a volumetric representation, by predicting the global pose of the camera using ICP, any depth measurement can be converted from image coordinates into a single consistent global coordinate space. This data is integrated using a volumetric representation. A 3D volume of fixed resolution is predefined, which maps to specific dimensions of a 3D physical space. This volume is subdivided uniformly into a 3D grid of voxels. Global 3D vertices are integrated into voxels using a variant of signed distance functions (SDFs), specifying a relative distance to the actual surface. These values are positive in-front of the surface, negative behind, with the surface interface defined by the zero-crossing where the values change sign. In practice, only a truncated region is stored around the actual surface—referred to as truncated signed.

With respect to Distance Functions (TSDFs), this representation has many advantages for the Kinect sensor data, particularly when compared to other representations such as meshes. It implicitly encodes uncertainty in the range data, efficiently deals with multiple measurements, fills holes as new measurements are added, accommodates sensor motion, and implicitly stores surface geometry.

Listing 2 below illustrates a projective TSDF integration leveraging coalesced memory access.
1: for each voxel g in x,y volume slice in parallel do
2: while sweeping from front slice to back do
3: vg←convert g from grid to global 3D position
4: v←T−1i vg
5: p←perspective project vertex v
6: if v in camera view frustum then
7: sdfi←∥ti−vg∥−Di(p)
8: if (sdfi>0) then
9: tsdf i←min(1, sdfi/max truncation)
10: else
11: tsdf i←max(−1, sdfi/min truncation)
12: wi←min(max weight, wi−1+1)
13: tsdf avg←(tsdfi−1*wi−1+tsdfi*wi)/(wi−1+wi)
14: store wi and tsdf avg at voxel g

### Listing 2

With respect to volumetric integration, to achieve real-time rates, a GPU implementation of volumetric TSDFs is described. The full 3D voxel grid is allocated on the GPU as aligned linear memory. Whilst clearly not memory efficient (a 5123 volume containing 32-bit voxels requires 512 MB of memory). This approach is speed efficient. Given the memory is aligned, access from parallel threads can be coalesced to increase memory throughout.

With respect to raycasting for rendering and tracking, a GPU-based raycaster is implemented to generate views of the implicit surface within the volume for rendering and tracking (See pseudocode Listing 3, below). In parallel, each GPU thread walks a single ray and renders a single pixel in the output image. Given a starting position and direction of the ray, each GPU thread traverses voxels along the ray, and extracts the position of the implicit surface by observing a zero-crossing (a change in the sign of TSDF values stored along the ray). The final surface intersection point is computed using a simple linear interpolation given the trilinearly sampled points either side of the zero-crossing. Assuming the gradient is orthogonal to the surface interface, the surface normal is computed directly as the derivative of the TSDF at the zero-crossing. Therefore each GPU thread that finds a ray/surface intersection can calculate a single interpolated vertex and normal, which can be used as parameters for lighting calculations on the output pixel, in order to render the surface.

Listing 3 below corresponds to raycasting to extract the implicit surface, composite virtual 3D graphics, and perform lighting operations:
1: for each pixel uεoutput image in parallel do
2: raystart←back project [u, 0]; convert to grid pos
3: raynext←back project [u, 1]; convert to grid pos
4: raydir←normalize (raynext−raystart)
5: raylen←0
6: g←first voxel along raydir
7: m←convert global mesh vertex to grid pos
8: mdist←∥raystart−m∥9: while voxel g within volume bounds do
10: raylen←raylen+1
11: gprev←g
12: g←traverse next voxel along raydir
13: if zero crossing from g to gprev then
14: p←extract tri-linear interpolated grid position
15: v←convert p from grid to global 3D position
16: n←extract surface gradient as ∇tsdf (p)
17: shade pixel for oriented point (v, n) or
18: follow secondary ray (shadows, reflections, etc)
19: if raylen>mdist then
20: shade pixel using inputted mesh maps or
21: follow secondary ray (shadows, reflections, etc)

### Listing 3

### Global Registration Problem

Referring to FIG. 7, with respect to global registration, the number n scans around an object is given with the goal to align them all. In a first attempt, the ICP each scan to one other (consecutive frames). Thus, a method for distributing accumulated error among all scans may be desirable.

There may be several global methods to address the above-noted problem, but their computation is relatively heavy, for example, because the optimum approach may be to estimate all RT of each frame that minimizes the global 3D distance error. Usually those techniques use a smart sub-set of all possible frames.

A partial approach to address this problem is to consider the extraction of a piece of model from the fused model with the same view of target model. In this manner, the error is not more propagated between consecutive frames, but it is spread on the fused global model. In fact the fused global model is a bit different from the target because it is the result of integration of all previous frames. This approach is used by the current embodiments and also by the Kinect fusion approach, point 3 of Listing 1.

Referring to the flowchart 20 in FIG. 10, beginning at Block 22, a subject is extracted for a given image from a plurality of image frames (Block 24). At Block 26, a coarse rotation and translation (RT) estimation of the extracted subject is performed. At Block 28, points of the image frame in at least one of the previous image frame and the next image frame that are outside a threshold boundary of frustum, the visible volume of a specific view, (e.g. based upon the coarse RT estimation) are removed. First, second image-point subject models are generated based upon the previous and next image frames, respectively, and may be generated based upon less than an entirety of the next image frame. More particularly, the target is not used directly, but using the same visible view of target, a new piece of the 3D model is extracted from the global 3D model to have a more robust target, for example (Block 30). At Block 32, a first ICP algorithm is performed on the first and second image-point subject models to produce common, or shared, points. The ICP converges to an optimal or sub-optimal registration or RT estimation after a certain number of iterations. The ICP stops iterations when the global 3D distance error is low enough. The proposed approach divides the iterations into two phases. All iterations of the first phase use all points. When the global error is medium, but not low enough to stop, the ICP uses only common points, so uncommon or not common (i.e. not shared) points are removed at Block 34 to define updated first and second image-point subject models. Common points are the points visible from target and source views. They are not detectable at the beginning because RT is yet unknown, so it is typically necessary during the first phase to allow a correct correspondence between the source and the target to discover common points. A second ICP algorithm is performed on the updated first and second image-point subject models to define further updated first and second image-point subject models. More particularly, the second phase is without uncommon points that generate noise to estimate the optimal RT (Block 36).

A fine RT estimation is performed at Block 38, and a luminance equalization is performed to the common points, e.g., by calculating coefficients of equalization at Block 40 that will be re-used into final paint stage. At Block 42, a depth map is generated between the further updated first and second image-point subject models. The further updated first and second image-point subject models are linked based upon an amount of overlap in the depth map.

At Block 44, the previously processing next image frames are accumulated, linked and outliers are removed to the further updated second image-point model. A normal is extracted and a density test is performed to reduce redundant points coming from the further updated second image-point subject model based upon a threshold number of neighbors for a given point in the further updated second image-point subject model (Block 46). At Block 48, a 3D image is generated based upon the further updated first image-point subject model and the further updated second image-point subject model after performing the second ICP algorithm. The method ends at Block 50.

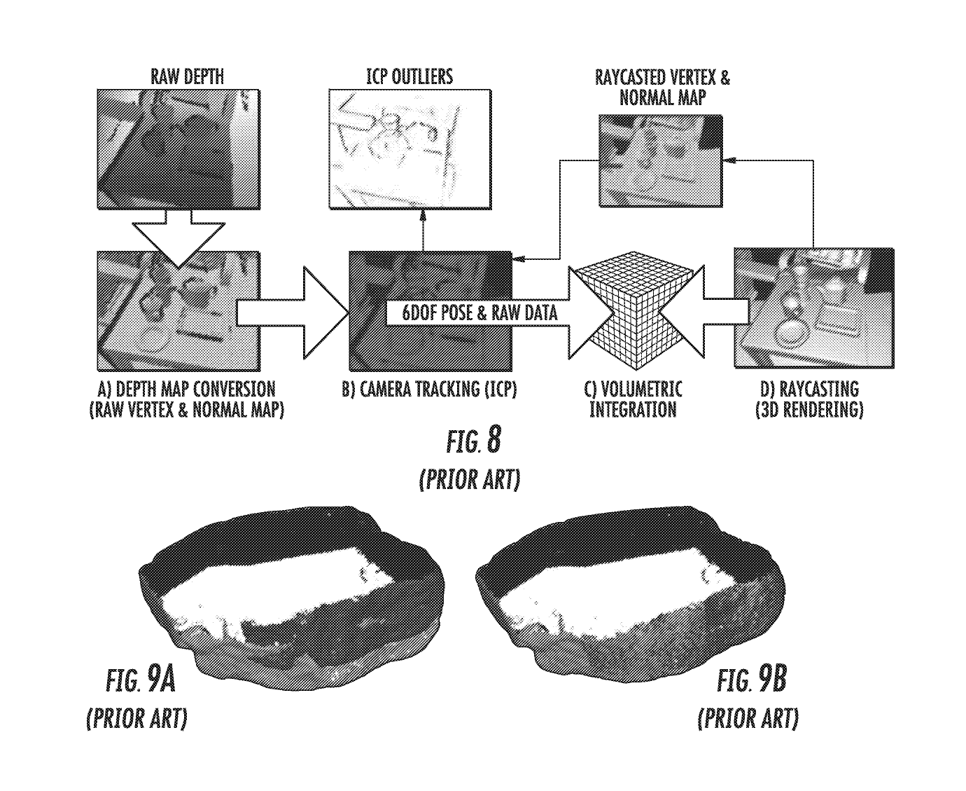

Referring now to the flowchart 120 in FIG. 11, further details of processing 3D images are described. The embodiments described herein include a pipeline chain. Each stage of the pipeline chain will be described below in separate sections. An overview of a fully functional pipeline is described. The subject extraction module or circuitry removes a full scene except for the subject and maps RGB into a depth map for each current frame (Block 122). It may be possible to avoid this extraction if the goal is the entire scene.

The coarse estimation module or circuitry receives the RGB-Z cut stream and tries to estimate a not-trivial coarse RT (Block 124), so the next stage (i.e., removing 3D points) can remove the out screen 3D points (Block 126) because the RT is almost known. The source sampling (Block 128) is applied to speed up the K-d tree search. A standard ICP is computed, but a variant based on a double cycle with different ICP parameters is applied.

The source is sampled, while the target is not the original, but it comes from the extraction of global model with the same target view. The extraction reduces error propagation accumulation due to consecutive frames. Inside this module, luminance equalization between two consecutive frames is computed for a correct re-painting into the post-processing stage. A standard SVD is processed to estimate the RT starting from the relatively good correspondences of ICP (Block 130). The full source linking (Block 132) is possible because the RT is known, so an association based on a depth map global-source instead of a full ICP is applied. The last N full source are stored and linked to the global model, but the fusion is delayed. After N frames (Block 134) the fusion is applied (Block 136), but is not a simple linear interpolation of all 3D points. Generally, only points above a threshold number of links with the global model are taken. Only points very close together may be considered desirable for a fusion.

After this selection a linear average is computed. The target is extracted from the global model (Block 138), so a cleaned model is desirable. An approximated normal is processed and a density test (Block 138) is performed. This test cleans the model before extraction. In post-processing, i.e., after the last frame (Block 140), another filter based on age and the removal of standard 3D outliers are applied (Block 142). If the current frame is not the last frame (Block 140), the target may be considered equal to the source (Block 144) and a target extraction from the global model is performed (Block 146) before returning to Block 122. Finally, a re-painting based upon stored images with angles of 45 degrees between their z axes is computed (Block 142). Further details of the operations described above will now be described.

Subject Extraction

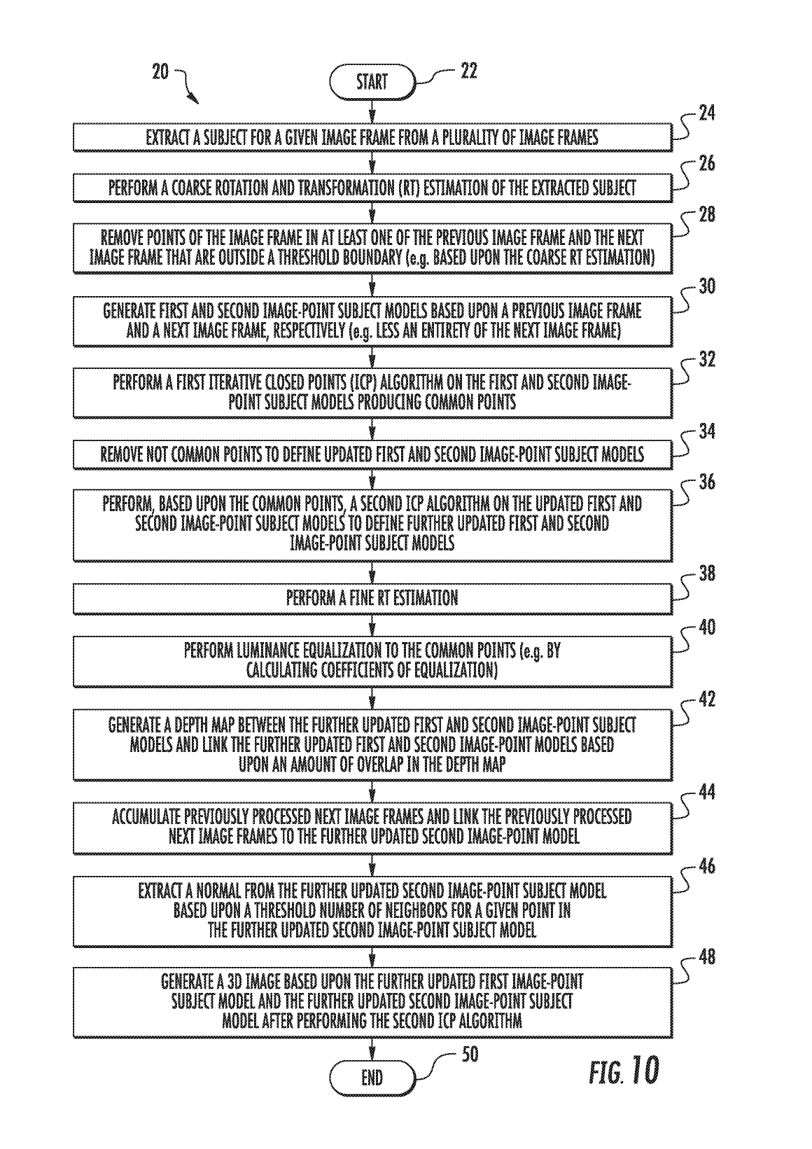

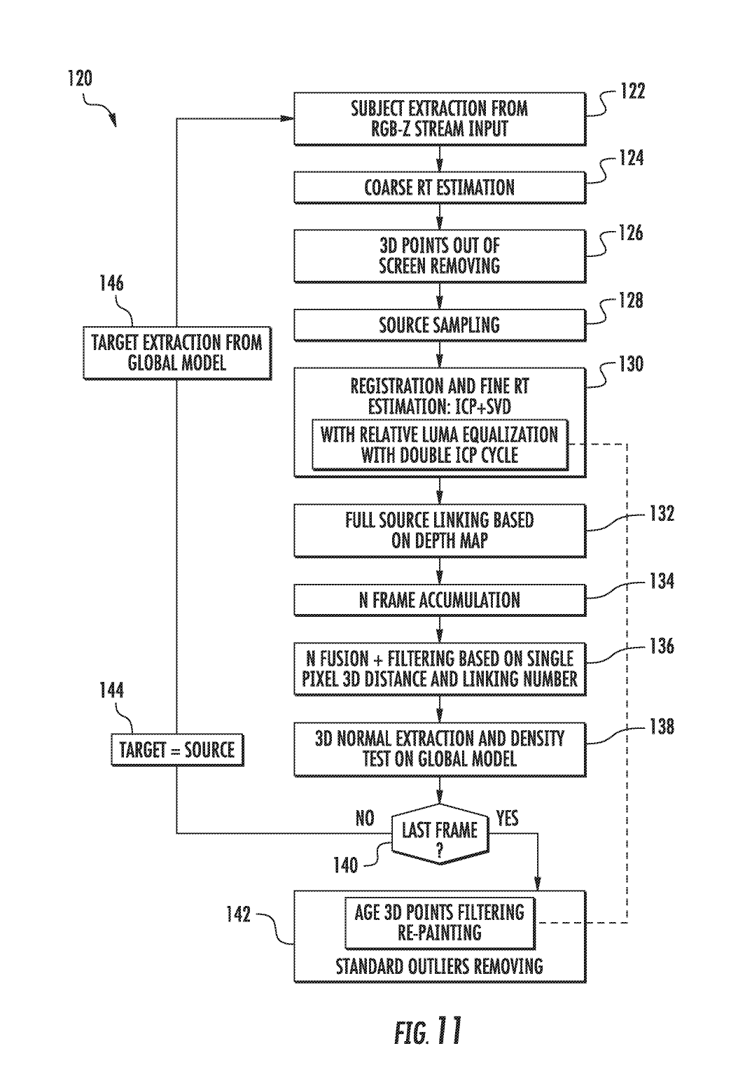

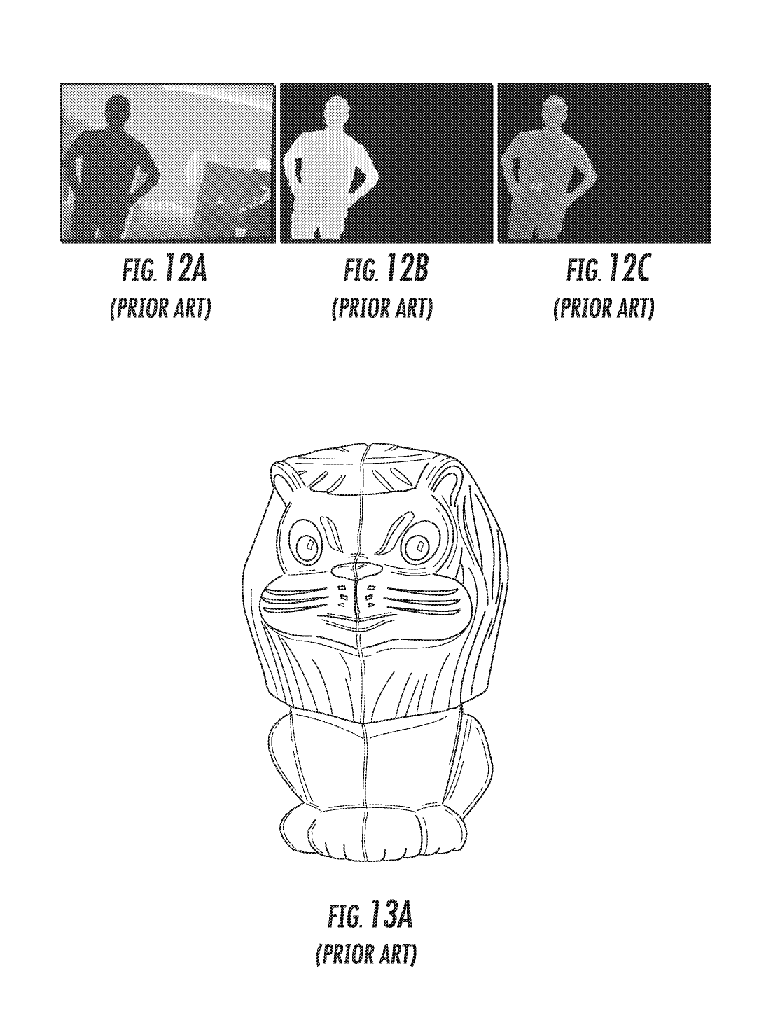

If it may be desirable to only to scan a single subject, then it may be better to automatically isolate the subject from the scene. In this way the full chain processes fewer 3D points, and the robustness of registration increases. Below are some examples of the subject extraction (FIGS. 12a-12c).

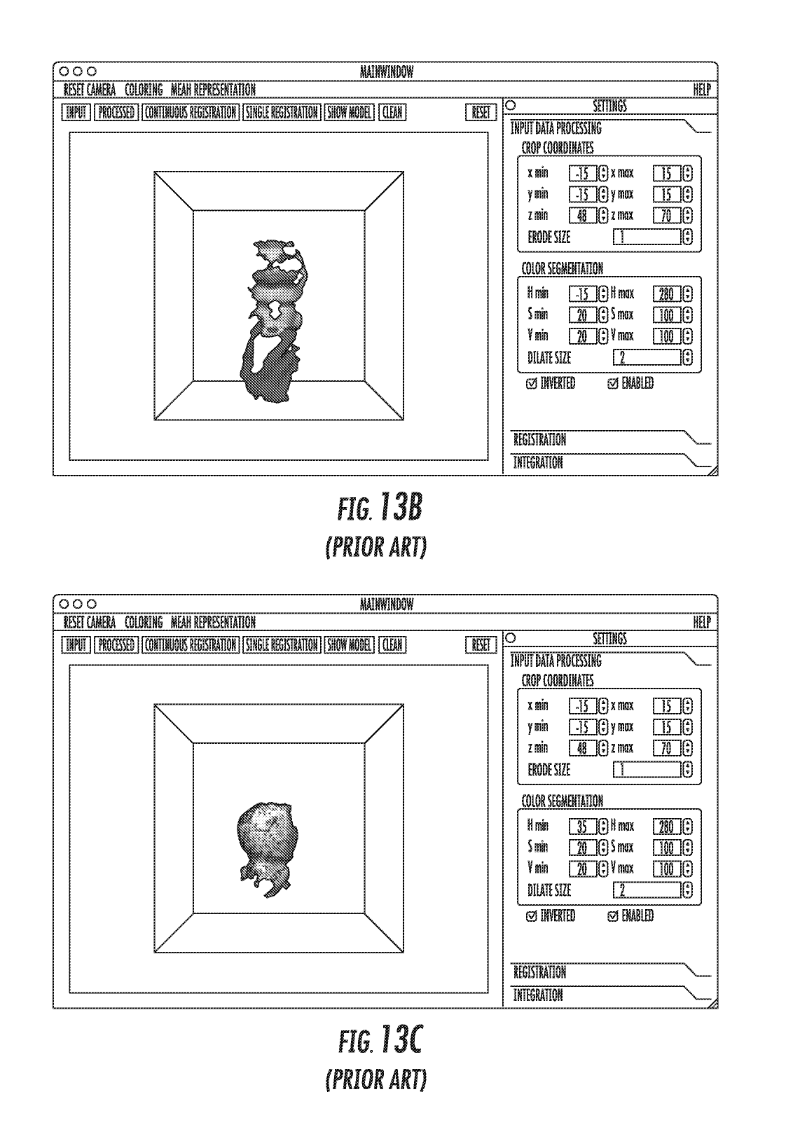

Illustratively, the subject is isolated. The state of art suggests defining a known fixed box range, to put the subject inside and remove the other elements, different from subject, using a known fixed RGB color not used by the subject, as described above. In fact, to hide the hand a colored glove is used (FIGS. 13a-13c).

The proposed method is more robust and requires less constraints than prior art approaches. A known fixed box depth range is defined, which bounds only about the z value while x and y ones are free, but other objects inside are automatically removed. From FIGS. 14a and 14b, it can be seen that another object falls into box, but in the final extraction, the another object disappears (See FIGS. 12a-12c). The assumption for the first frame is that the subject is closer to center of box than other objects. The subject is typically bigger than others and the objects are isolated between them. For next frames, the assumption becomes less stringent. In fact, it is generally sufficient that the objects are yet isolated, but the subject is the closest to previous position. A histogram of depth and x axis is computed to discover where the objects are located. The objects are isolated, so bells in the histograms will be found, the peak of each bell being the position of object. The crossing of x bells and z bells gives the x, z coordinates. For the first frame there are two levels of selection. The first one includes the selection of most closed position to the center box. The next step is to find all other objects that are close to the selected object, for example, within a 30 cm tolerance. The last step is to select the largest among all candidates. For next frames, the selection is based only on closest bell to the previous position. This method is much more robust and the subject can have any type of colored dress.

Coarse RT Estimation

The registration or camera tracking problem requires a relatively good starting point before independently starting using any type of method. The correct matching between two 3D models may have only one solution only if the models are identical. When a view changes, the depth map also changes, so the common 3D points between two different views are not 100%. This means that the uncommon 3D points could generate local solutions instead of a unique global solution. For this reason it may be desirable to have a closed starting point relative to the global solution.

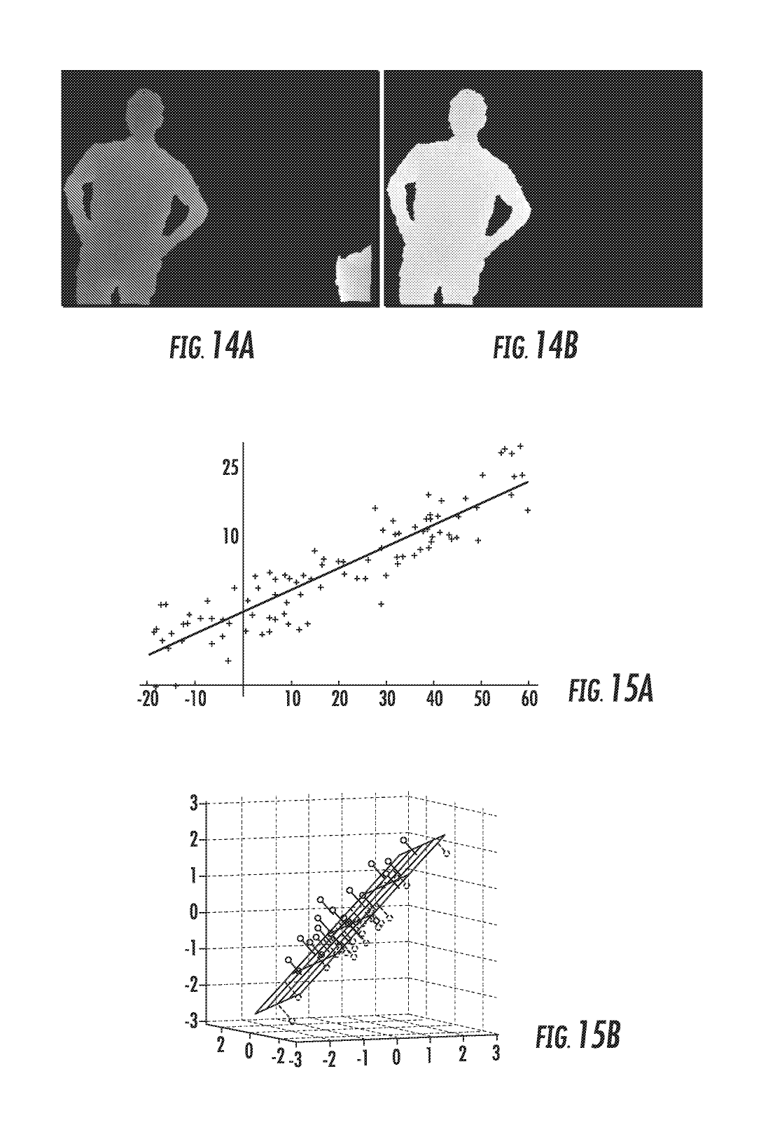

In this way, the convergence towards the optimum may be granted. The challenge is to estimate a good coarse RT without knowing the optimum RT. The state of art suggests, as a starting point, the translation of the source model barycenter towards the target barycenter. If models have relatively a lot in common, this may be relatively good except for the R component. The method also estimates a coarse R to have a better and safer start point. The first step is to calculate the 3D plan that fits a 3D point cloud. It may equivalent to a linear regression calculation (FIGS. 15a and 15b).

The origin axis of the regression planes are yet the barycenter, so the alignment of the target and source planes also includes the barycenter (FIGS. 16a and 16b). If common points are much more of uncommon ones, then the regression plane represents a relatively good average of the 3D cloud, so it is generally sufficient to align the planes to align also the 3D models.

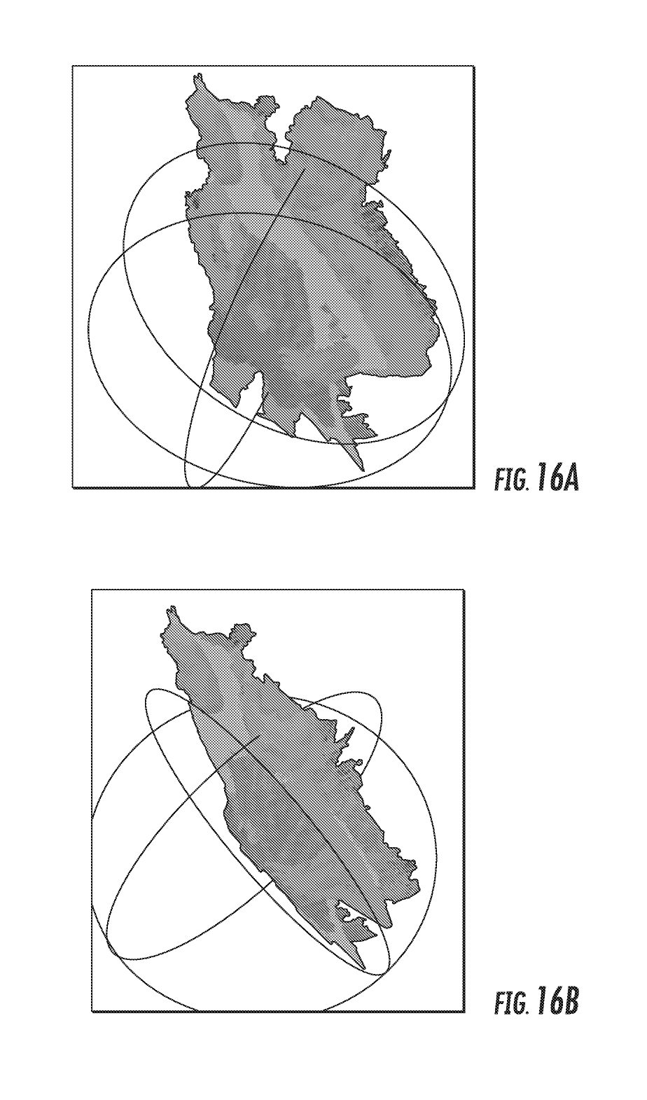

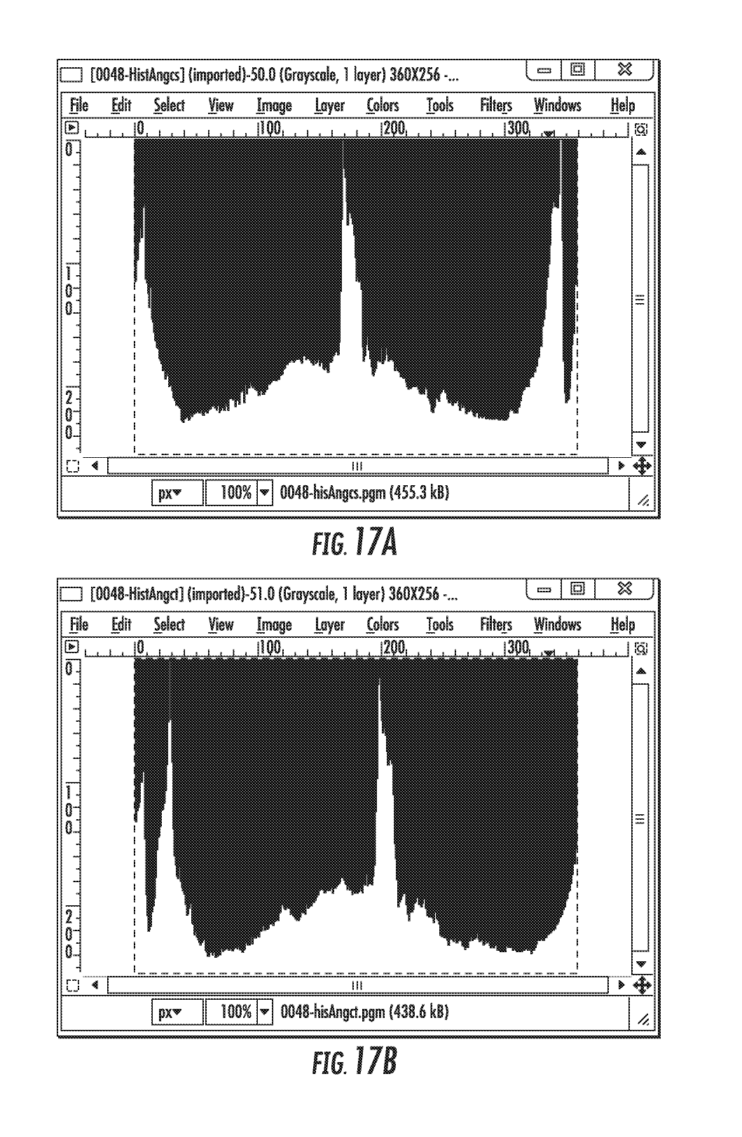

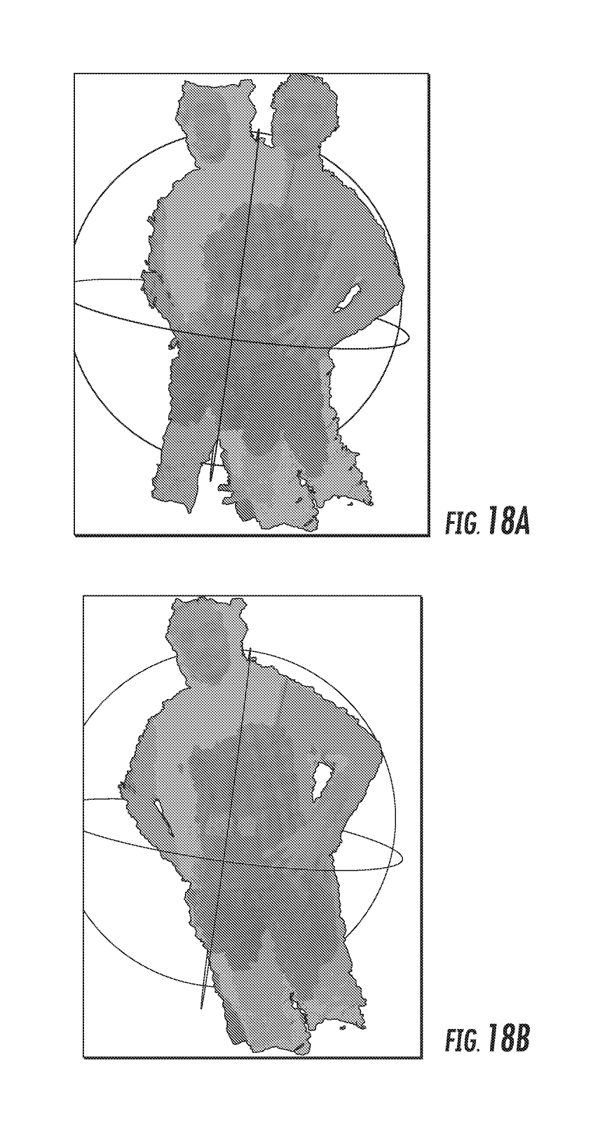

As can be seen, the alignment between source and target is not completed. The last internal rotation is to be completed. This is addressed via a histogram of angles. The plane is split into 360 degrees with a radius belonging to the plane and starting from the barycenter of the cloud. Each occurrence of each angle is counted to build the histogram. The next step is to consider the highest bell peaks and to shift the target and source histogram until they are matched (FIGS. 17a and 17b). The matching may be the best for all bells, not only for the highest. The shift is equivalent to find the internal rotation (FIGS. 18a and 18b). If the models were exactly the same, this method may give the optimum RT without using the ICP.

3D Points Out Screen Removing

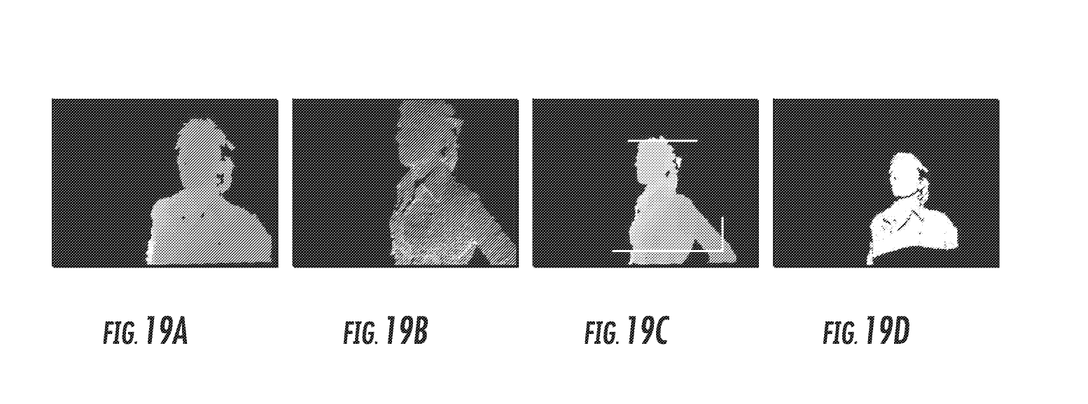

Based upon the coarse RT estimation, it may be possible to remove points out of the screen. In particular, it is possible to apply this RT to the source to build the depth map with a similar view of the target, and it is also possible to apply this RT inverted to the target to build the depth map with a similar view of source. The points out screen will be removed before application of the ICP (FIGS. 19a-19d). After this operation, the original model is changed, and the common points are increased. Also, the regression planes are different, so the coarse RT estimation is repeated until the number of points removed is almost the same of previous iteration, which means that the RT estimation is confirmed.

The source sampling is a standard stage, and the approach adopted here may be considered state of art. ICP uses a k-d tree to organize data and to allow a fast minimum distance research between a point of source and all points of the target. In fact, the complexity is Ns*log Nt if the models have Nt points for the target and Ns points for the source. To speed up searching, the source model is typically always sampled before application of the ICP. The selected subjects are human bodies, and for them a fixed simple sampling may be sufficient (a regular grid into source depth map). A tuning of sample rate may be necessary to discover the correct sampling rate.

Target Extraction from Global Model

As explained above in the state of art, the global registration is not granted if the ICP is applied only between consecutives frames. In particular, all subjects are scanned at 360 degrees to have the full subject, so the alignment with the start and end global model could be wrong (FIGS. 20 and 21). A partial approach of this problem may be to consider the extraction of a portion of the fused model with the same view of the target model. In this manner, the error may not be further propagated between consecutive frames, but it is spread on the global model fused. In fact the global model fused is a bit different from the target because it is the result of integration of all previous frames. The extraction from the global model generally requires separating the 3D points associable with the target from the other ones. The points out of the screen with the same view of the target are removed. The points with a normal that are not oriented towards the camera are removed. This occurs by testing the sign of the dot product between normal and view vectors. Also, the Kinect fusion method extracts the target from global.

Registration or Camera Tracking

The registration is based on classic ICP, while the RT estimation is based on the SVD method. The classic ICP finds the correspondences between the target and the sampled source. Each correspondence is the couple source-target points with the minimum 3D distance. A variant ICP uses the distances between a point and the tangent plane. In general, there are a lot of ICP variants for this technique. The searching of correspondences is based on a k-d tree exploration. The complexity is Ns*log Nt if the models have Nt points for the target and Ns points for the source.

The SVD calculates the RT that minimizes all those distances. The ICP iterates the k-d tree exploration and SVD calculation until a convergence towards a minimum is reached. The convergence criteria define the parameters to stop iterations. They are the maximum number of iterations, the variance of RT coefficients, and the minimum average 3D distance. Inside the ICP loop there is also a rejection to remove bad correspondences. There are several type of rejections: maximum 3D distance, maximum color distance, and maximum angle between normal and univocal correspondences.

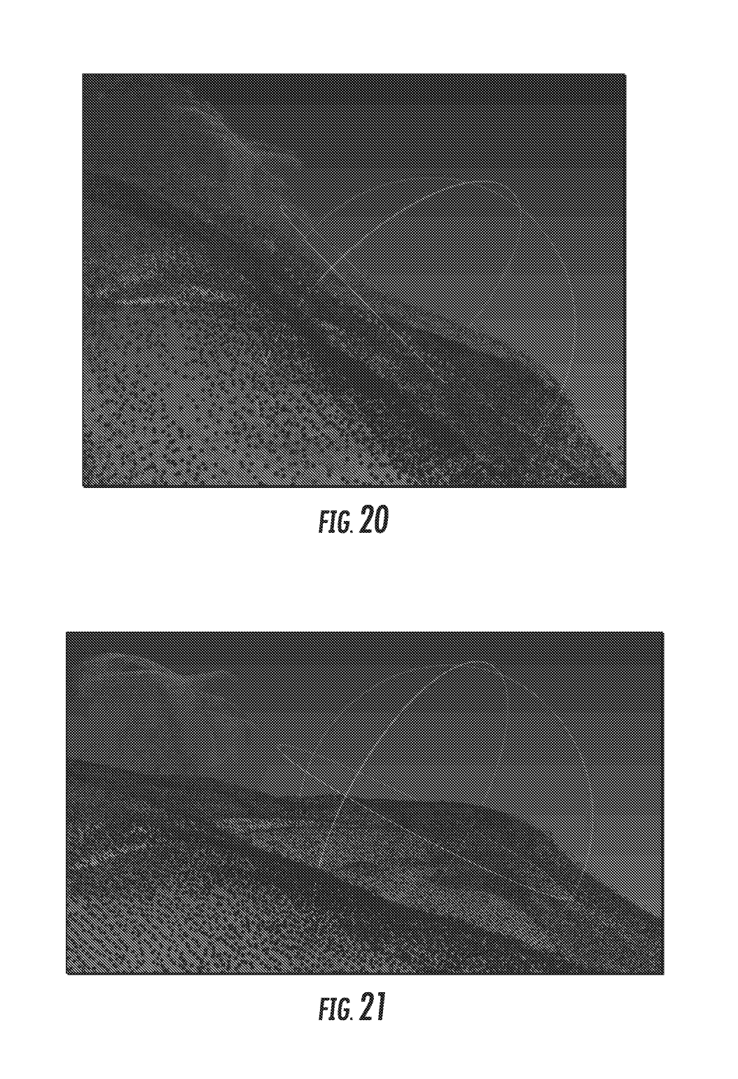

Univocal correspondences play a central role. In fact, they are an approximated way to consider all points or only common points. The uncommon source points are linked with same target points of common source points, but common ones have a shorter distance, so the uncommon ones will be discarded (FIGS. 22a-22c). Unfortunately the source is sampled, so some uncommon points could have a target point not linked with a sampled source point. The property of the univocal test suggests a new variant of ICP. A double ICP cycle is applied. The first cycle does not apply any rejection, and the parameters of convergence are lighter, so the number of ICP iterations is reduced. In this phase, the uncommon points move the source model toward a global minimum even if the starting position is not optimal or close to a local minimum. In fact, some uncommon points after a correct RT estimation will generally become common points, but at the beginning will be removed if the univocal test is enabled. When the source and target are relatively close to the global minimum, the uncommon points could move wrongly toward the source because the majority of them are really uncommon, so it may be desirable to use only common points with rejection enabled to increase the quality of correspondences. For this reason a second ICP cycle is applied with rejection enabled and stronger convergence criteria. The result is an ICP that is more robust and faster.

Another function is added to the ICP to address the problem of RGB images not being equalized in the same manner. Unfortunately, the Kinect device provides RGB much darker or lighter between images to compensate for the external light conditions. The camera is typically always running around the subject so this behavior has a strong impact. If a variant of ICP also uses color distance to estimate RT, it could become a problem. Thus, a better space color selection may be desirable. CeLab color space reduces the impact of this behavior. The ICP used here does not consider color distance or strong color rejection. The reason of equalization is for the painting stage in post processing. That module will use a sub-set of RGB images to re-paint the global model, but equalization is desirable during the ICP phase. The easiest way is to take a reference image and then equalize it to the other images, but the color of the subject could change with different view. For example, if the front subject is black, and back one is white then images are darker or lighter because it is corrected. For this reason the equalization may be done only for common points found by the ICP between closed views. The equalization of the source is applied for each frame using the common point target to calculate the coefficients of equalization (additive and product constant applied to Luminance).

The method may include:

calculation of alpha and beta parameters for compensation using only common points:

Σ(Lₛₓ−L_{dx})² [symbol] Σ((α·Lₛₓ+β)−L_{dx})²

From SSD of Luma, it is possible to calculate alpha and beta, the goal being to reduce the differences adding alpha like a multiplier, and beta like an offset for color compensation. A derivativative of SSD by alpha and beta=0 gives the minimum values of SSD.

2αΣ(Lₛₓ)²+2βΣLₛₓ−2Σ(Lₛₓ·L_{dx})=0 and 2Nβ+2αΣLₛₓ−2ΣL_{dx}=0

Below is the solution:

$$α = \frac{N \sum ( {L}_{sx} \cdot {L}_{dx} ) - \sum {L}_{sx} \cdot \sum {L}_{dx}}{N \sum {( {L}_{sx} )}^{2} - {( \sum {L}_{sx} )}^{2}} and$$

$$β = \frac{\sum {L}_{dx } - α \sum {L}_{sx}}{N}$$

Finally, the compensation is applied on the whole source image, with the first equation with alpha and beta.

Full Source Linking

After RT estimation, the next step is to link the source model to the global model. The ICP stage gives the linking between the global and sampled sources. The application of ICP between the global and the source and only iteration gives the linking, but it is computationally heavy. A better way includes, on a depth map, overlapping the global and source to project the 3D model using their view and known projection parameters. The global and source with the same pixel is associated. This association allows the fusion between source and global. The fusion is not a trivial average, but it includes another new method.

N Frames Accumulation-N Fusion-Filtering

This stage is responsible for the quality of fusion. A safe or robust fusion may be possible if at least 3 frames are considered in the same time, for example, accumulating the last N source models linked to the global model. The fusion is not the average of linked points, but the points are selected beforehand. Only points closed between them are selected. Besides, a minimum threshold of M links may be desirable where M>1 and M<N. Points strongly linked and that are confirming a x, y, z position are used for fusion. If the 3D sensor device does not give, temporally, a good 3D position or the tangent surface plane is not enough frontal versus the camera, then some points could be far from the other linked ones, so this method is more robust and safe. An adaptive global model that can change shape if the subject is deformed is thus generated. Neighbors are not used in this technique, only points linked to the same pixel of depth map are used. Neighbors will be considered into next filters as will be explained below. The state of art applies a simple average or weighted average. In fact, Kinect fusion gives almost the same weight to the global model and the source model. In the Kinect fusion mode, the global changes shape with the newest model, but it does not know if the new model is good or bad. Thus, the method described herein is more robust about shape changes (FIGS. 23a and 23b).

In other words, instead of a simple average of 3D points coming from the global and the next frame, the last N frames are considered before adding the new points. Each frame with its piece of 3D model is stored into a circular buffer of N frames. In particular, it is stored in the depth map of each frame, where points of different frames with same x,y coordinates are linked. In fact, the ICP has linked the 3D points between the N frames. 3D points are linked almost one time between N frames, so a point without a link is removed (unsafe point, not confirmed). The points with same x, y coordinates are compared. The points with not similar Z are removed (unsafe point, Z not similar). FIGS. 23a and 23b, for example, illustrate the advantage of this approach. In fact, the first wrong 3D model is fully removed from the final global model because the 3D points with same x, y coordinates have different Z respect the correct 3D model (wrong points are usually few, while good points are usually a lot).

Normal Extraction and Density Test and Density Stabilization

In this stage, the normals of the global model are calculated with an innovative approximation, and the same method also gives a density test. The normals are usually calculated using the first K neighbors of the point selected. If k points are too much far or near, then it is not important, but it is desirable. A preferred way is to use all points inside a sphere with a fixed radius. In this way, the surface inside the sphere, if unique, gives the normals and the possibility to measure the density. The normals are calculating by using the 3D plane regression, which is based upon the assumption that inside the sphere there is only one surface, otherwise wrong normals will be generated. Very small spheres give a relatively high probability of one surface. The normal of the plane is associated to all points inside the sphere. For this reason the method is approximated. A linear interpolation between spheres would give a smoothed normal, but it is computationally heavy and may be unnecessary for our current target precision.

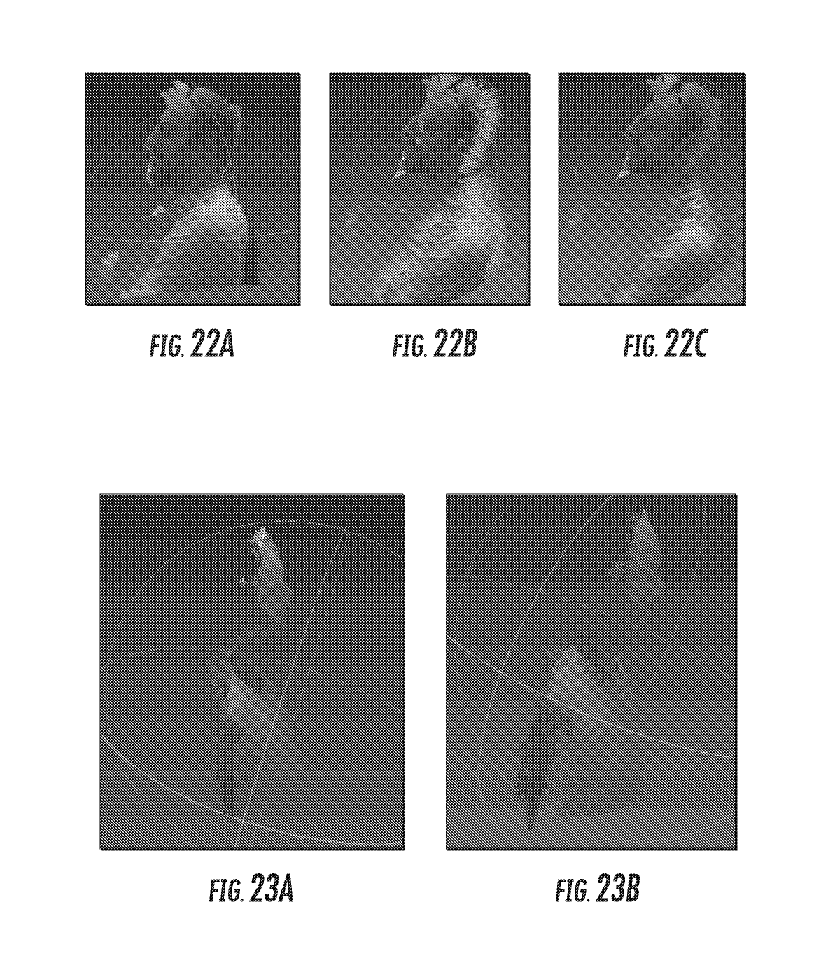

To find the points of a known sphere is also computationally heavy. An octree data organization based on a voxel is used to speed up the processes. The first step is to find the voxels covered by the sphere and then points inside the voxels. The sphere is also useful for a density test and also for an adaptive sampling to fix the density inside a sphere. Before describing how this is done, it is important to know that the global model must generally be cleaned before the extraction of the target from it. The Kinect device gives a depth map with the border not well defined (FIG. 24). The borders are a bit cut before fusion, but the cut width is fixed, so it is not possible to grant a good border. If the depth is wrong, it will generally be added into the global model. If ICP fails due to a minimum local, a bad fusion occurs.

To ensure a cleaned global model an innovative density test is applied. A density test is not trivial. To estimate how many points should be inside a sphere depends on the geometry of surface, the position of camera, distance between the sphere, the resolution of camera, and the radius size of the sphere. To discover a good approximation, it may be better to demonstrate the formula steps by steps. For each voxel of the octree, a free point is taken. It becomes the center of sphere with a radius higher than the voxel size to have only one sphere for each voxel. The busy point is already used by a previous sphere while the free points are never used. It means that the center of sphere is also the center of tangent plane surface. The 3D points of a surface are the result of a projection sampling of camera, so their number is fixed by the camera resolution. The first approximation is one surface inside the sphere, and the surface is almost planar. The first step is to calculate the number of NO of points with depth=1 m, plane frontal to camera, and sphere projected to screen center (FIG. 25).

The projection matrix is typically known because the system is calibrated, so the intrinsic K parameters are known (K depends on screen size and focal lens). Applying a simple projection by K*RT, NO is found. Into first step, also secants are approximated to radius.

N0=C0*r² (1)

Where C0 is a coefficient and r is the radius

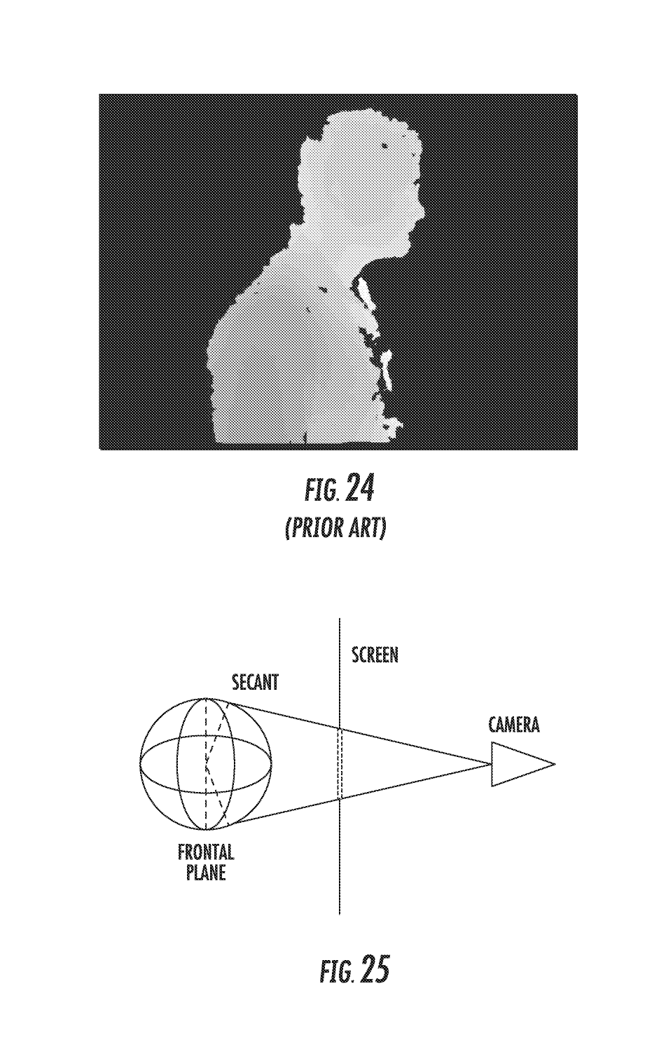

The second step is to consider different depths (FIG. 26). Considering the similar triangles, it may be relatively easy to discover that the projection is inverted with respect to depth, and the area is the square of it. The number of points is proportional to the area projected.

$$N 0 = C 0 * {r}^{2} * \frac{1}{{z}^{2}}$$

The third step is to consider a different view vector with same depth (FIG. 27). A sphere could have a view different from Z axis, but any view is equivalent to a second case if the area is divided by the cos between view vector and z axis. To be precise, the triangles with dashed lines are the result of a simple rotation, but the triangle with not dashed line is almost the same. The worst case is the end of screen, but the field of view is not usually much larger.

$$N 0 = C 0 * {r}^{2} * \frac{1}{{z}^{2}} * \frac{1}{cos ( view - zaxis )}$$

The last step considers the plane inside the sphere (FIG. 28). It may not be frontal to the screen, so the area is proportional to the cos between normal plane and z axis.

$$N 0 = C 0 * {r}^{2} * \frac{1}{{z}^{2}} * \frac{cos ( normal - zaxis )}{cos ( view - zaxis )}$$

This is the approximated estimation of density. After the normal calculation based on the regression plane inside the sphere, the same sphere is also used to remove outlier points lower than a minimum density.

If the density is higher than a maximum density then a sampling to fix the increasing number of points is applied. The same regression plane is used to project all points on it. The plane is divided as a fixed grid. A simple average of point with the same grid coordinate is computed. A counter is associated with each point to know how many points are being represented. This counter is used by two stages: average calculation inside N fusion module and next stage called Age filtering.

Post Processing

After the last frames, the post-processing phase begins. The last outliers are removed and re-painting is applied.

Age Filtering

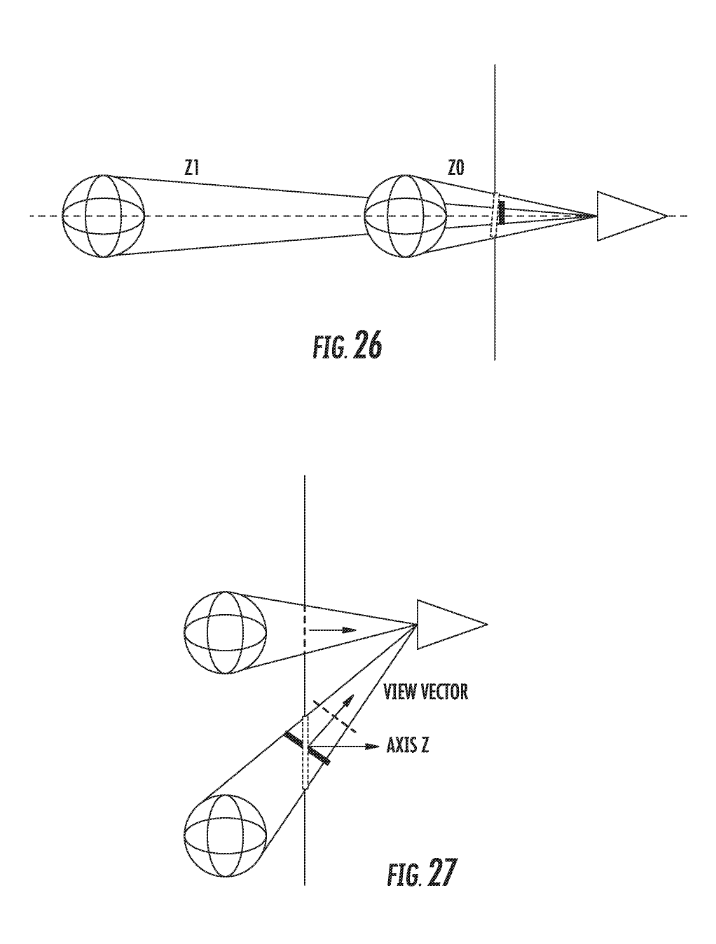

Age filtering is based on a counter view. Each point counts how many views confirm itself. The age counter is multiplied by the number that it represents. For each point, another counter is associated to know how many points it is representing after sampling is applied inside the density test stage. The threshold age is adaptive. The accumulation of the counter histogram is calculated to fix the threshold close to 85% of the population. Thus, 15% of total points at maximum are removed (See FIGS. 29a and 29b where the lighter colored points are confirmed and darker colored points are not confirmed).

Standard Outlier Removing

The last filtering removes the last outliers. A standard filter based on the K nearest points is applied. The distance distribution of k points from the points selected gives the standard deviation distance, called std, which is used to discover the out of distribution. The outlier points are higher than the mean+std*h, where h is a coefficient>1.

Re-Painting

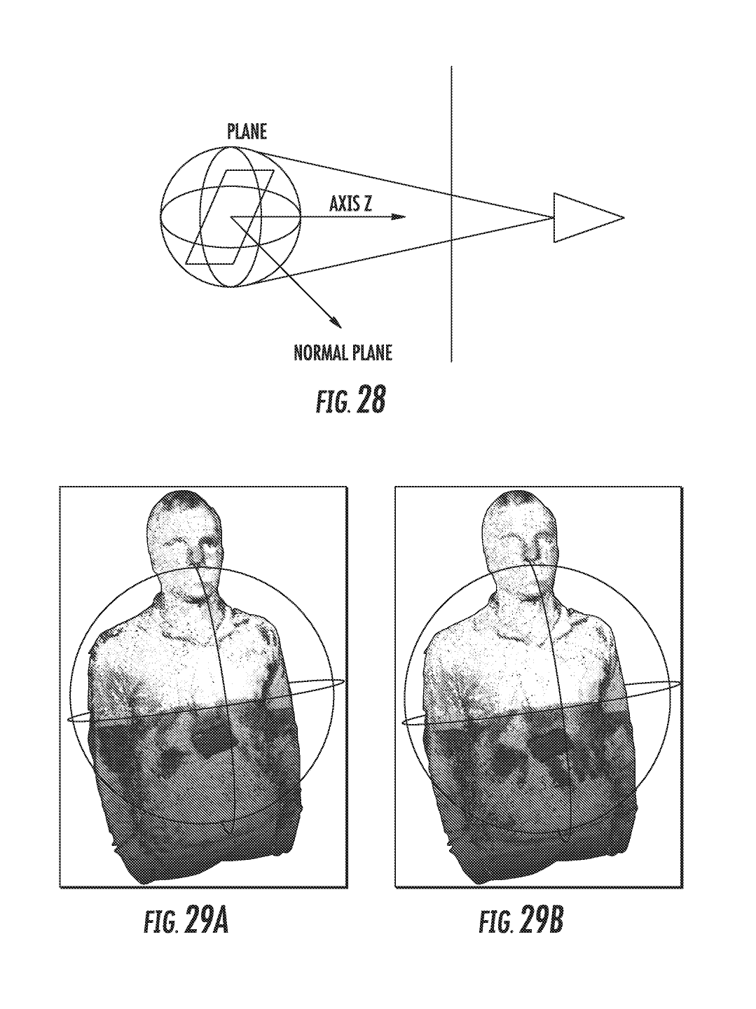

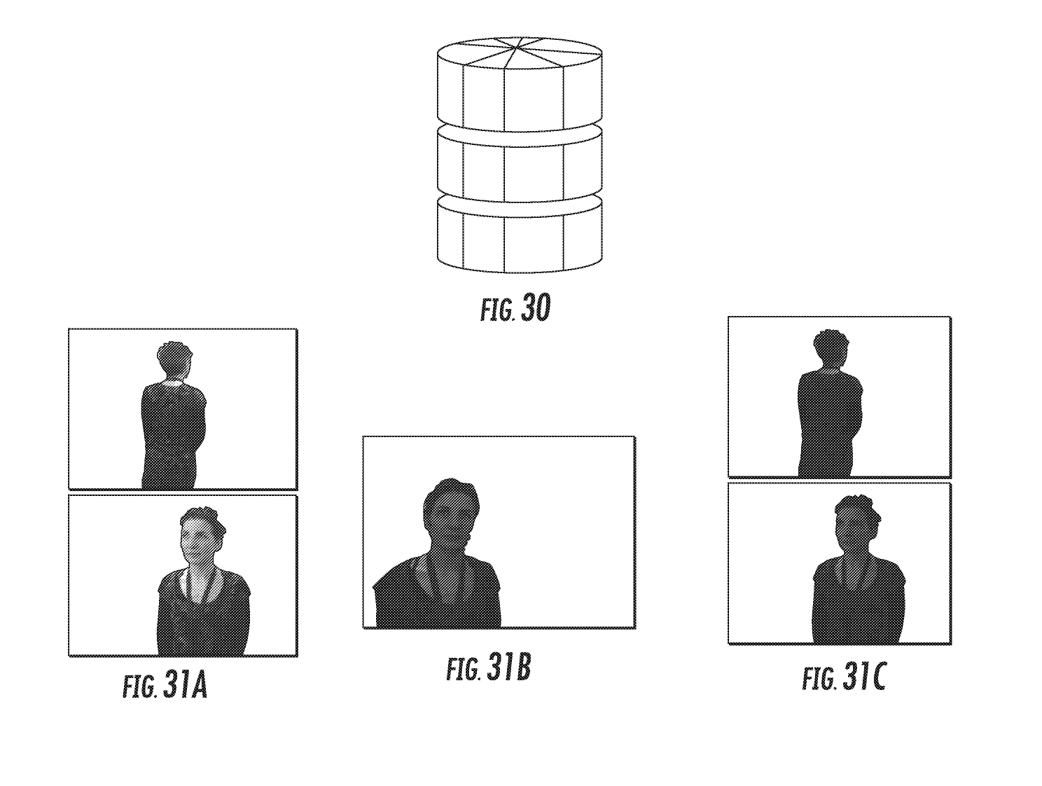

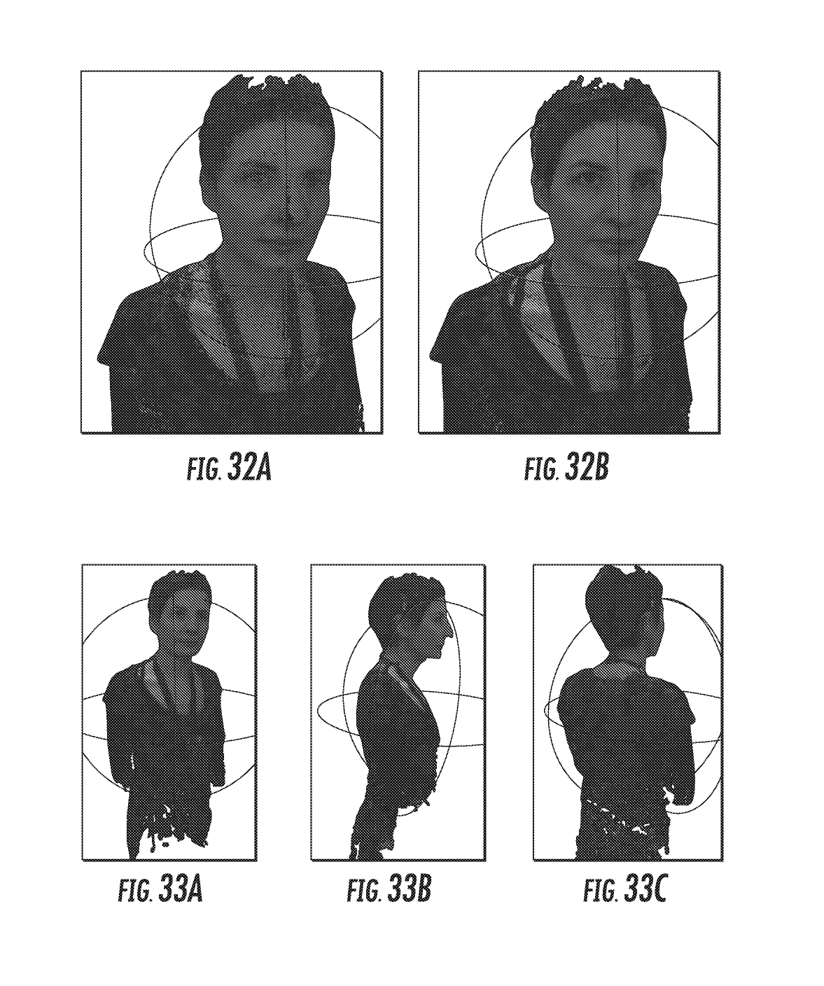

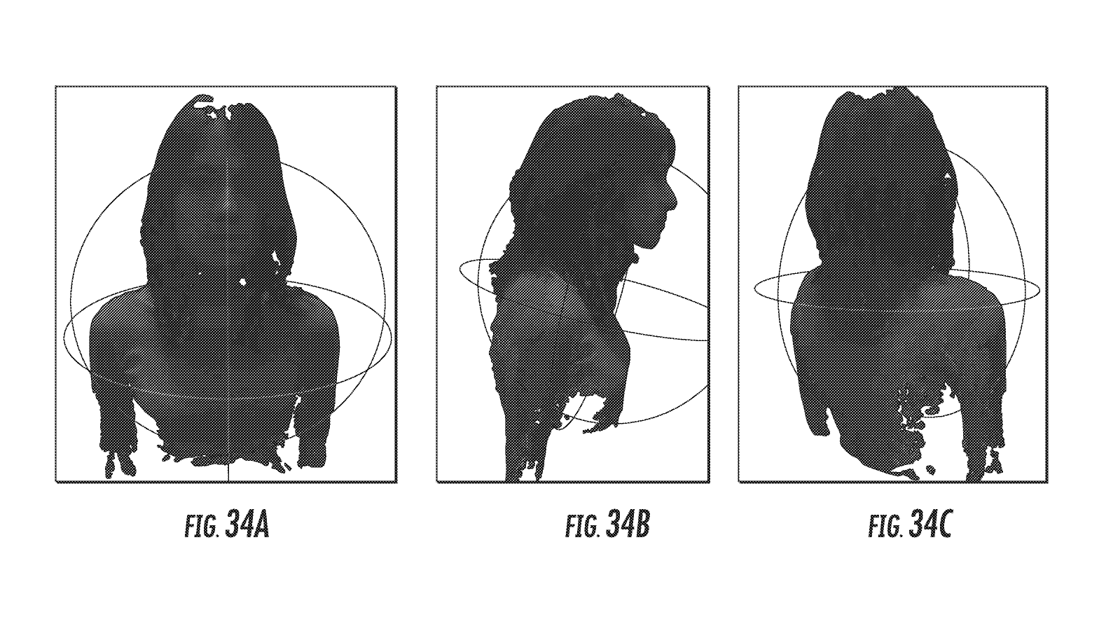

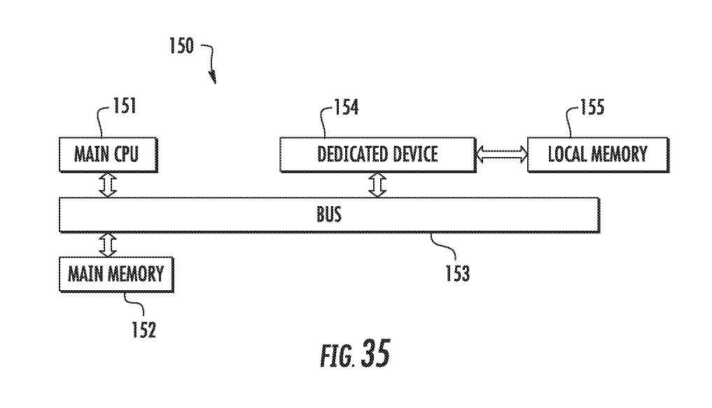

The re-painting stage improves the color quality of the global model using old RGB images. During building of the global model, the RT camera position is evaluated, so each frame has its own RT. In this way, it is possible to discover the angle between the relative z axis of the camera between different frames. The 3D space is quantized into fixed angles. In particular we have three cylinders: up, central, and bottom have the y-axis in common. Each circle of the cylinder is divided into slices of 45 degrees (FIG. 30). The quantized angles obtained become the angles for storing. The current frame angle closest to those fixed angles is captured, so the RGB images are stored with their RT. The RGB images are also equalized during the ICP phase (FIG. 30). The last step is to project the colors using the stored RT (FIGS. 31a-31c). Results of the image processing are illustrated in FIGS. 33a-33c and 34a-34c.

Advantages

The advantages are the following:

The subject extraction is more robust compared to the state of the art approaches. Other objects inside the box are removed automatically without a color strategy;

The coarse RT estimation based on regression planes and angle histogram also gives an R estimation, so the ICP or SDF starts from an RT closer to the optimum RT and the global minimum is granted more;

The double ICP cycle is more robust about possible local minima;

The N fusion provides a safer and correct shape adaptation of the global model during its building phase;

The density stage provides a relatively stable density and outlier removing better than a standard outlier removing based on k neighbors;

The age filters remove the confirmed points from few views;

and

The Re-painting module provides a relatively high RGB quality.

System Embodiment

Now referring to FIG. 35, the whole pipeline or system 150 may be embodied in software or software accelerated by a GPU or multicore system, or by a dedicated hardware or device 154 coupled to a local memory 155 and coupled to the main CPU via a data bus 153, which may implement the logic and math operations described above. The dedicated hardware can introduce a strong parallelism. The main CPU 151, for example, sends the address in the main memory 152 of the RGB-Z images via a data bus 153. After the parallel elaboration of this input, the global model address is sent to the main CPU 151.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A system for processing a three-dimensional (3D) image, the system comprising:
a processor and a memory cooperating therewith configured to
extract a subject for a given image frame from a plurality of image frames,
generate first and second image-point subject models based upon a previous image frame and a next image frame, respectively,
perform a first iterative closed points (ICP) algorithm on the first and second image-point subject models producing common points,
remove not common points to define updated first and second image-point subject models,
perform, based upon the common points, a second ICP algorithm on the updated first and second image-point subject models to define further updated first and second image-point subject models, and
generate a 3D image based upon the further updated first image-point subject model and the further updated second image-point subject model after performing the second ICP algorithm.

2. The system of claim 1 wherein said processor is configured to perform a coarse rotation and translation (RT) estimation of the extracted subject prior to performing the first ICP algorithm.

3. The system of claim 2 wherein said processor is configured to remove points of the image frame in at least one of the previous image frame and the next image frame that are outside a threshold boundary based upon the coarse RT estimation.

4. The system of claim 1 wherein said processor is configured to generate the second image-point subject model based upon less than an entirety of the next image frame.

5. The system of claim 1 wherein said processor is configured to perform luminance equalization based upon the common points.

6. The system of claim 5 wherein said processor is configured to perform the luminance equalization by calculating coefficients of equalization.

7. The system of claim 1 wherein said processor is configured to generate a depth map between the further updated first and second image-point subject models, and link the further updated first and second image-point models based upon an amount of overlap in the depth map.

8. The system of claim 1 wherein said processor is configured to accumulate a plurality of previously processed next image frames.

9. The system of claim 8 wherein said processor is configured to link the plurality of previously processed ones of the next image frames to the further updated second image-point subject models.

10. The system of claim 1 wherein said processor is configured to extract at least one normal from the further updated second image-point subject model based upon a threshold number of neighbors for a given point in the further updated second image-point subject model.

11. The system of claim 1 wherein said processor is configured to perform a fine RT estimation based upon performing the second ICP algorithm.

12. A system for processing a three-dimensional (3D) image, the system comprising:
a processor and a memory cooperating therewith configured to
extract a subject for a given image frame from a plurality of image frames,
perform a coarse rotation and translation (RI) estimation of the extracted subject,
generate first and second image-point subject models based upon a previous image frame and a next image frame, respectively, based upon the coarse RT estimation,
perform a first iterative closed points (ICP) algorithm on the first and second image-point subject models producing common points,
remove not common points to define updated first and second image-point subject models,
perform luminance equalization based upon the common points,
perform, based upon the common points, a second ICP algorithm on the updated first and second image-point subject models to define further updated first and second image-point subject models, and
generate a 3D image based upon the further updated first image-point subject model and the further updated second image-point subject model after performing the second ICP algorithm.

13. The system of claim 12 wherein said processor is configured to remove points of the image frame in at least one of the previous image frame and the next image frame that are outside a threshold boundary based upon the coarse RT estimation.

14. The system of claim 12 wherein said processor is configured to generate the second image-point subject model based upon less than an entirety of the next image frame.

15. The system of claim 12 wherein said processor is configured to perform the luminance equalization by calculating coefficients of equalization.

16. A method of processing a three-dimensional (3D) image, the method comprising:
using a processor and a memory cooperating therewith to
extract a subject for a given image frame from a plurality of image frames,
generate first and second image-point subject models based upon a previous image frame and a next image frame, respectively,
perform a first iterative closed points (ICP) algorithm on the updated first and second image-point subject models producing common points,
remove not common points to define updated first and second image-point subject models,
perform, based upon the common points, a second ICP algorithm on the first and second image-point subject models to define further updated first and second image-point subject models, and
generate a 3D image based upon the further updated first image-point subject model and the further updated second image-point subject model after performing the second ICP algorithm.

17. The method of claim 16 comprising using the processor to perform a coarse rotation and translation (RT) estimation of the extracted subject prior to performing the first ICP algorithm.

18. The method of claim 17 comprising using the processor to remove points of the image frame in at least one of the previous image frame and the next image frame that are outside a threshold boundary based upon the coarse RT estimation.

19. The method of claim 16 comprising using the processor to generate the second image-point subject model based upon less than an entirety of the next image frame.

20. The method of claim 16 comprising using the processor to perform luminance equalization based upon the common points based upon the first pass ICP algorithm.

21. The method of claim 20 comprising using the processor to perform the luminance equalization by calculating coefficients of equalization.
